(19) United States
(12) Patent Application Publication
(10) Pub. No.: US 2005/0070227 A1
(43) Pub. Date: Mar. 31, 2005

(54) Detecting and actuating method of bluetooth devices and a control system thereof

(76) Inventors: Chih-Hsiang Shen, Hsin-Chu (TW); Athene Tang, Hsin-Chu (TW)

Correspondence Address: RABIN & CHAMPAGNE, P.C., Suite 500, 1101 14 Street, N.W., Washington, DC, 20005, US

(21) Appl. No.: 10/673,399

(22) Filed: Sep. 30, 2003

(51) Int. Cl. H04B 1/00

(52) U.S. Cl. 455/41.3

(57) ABSTRACT

A method of detecting and actuating of a Bluetooth device and a control system thereof is dislcosed. When the Bluetooth wireless device is used for the first time, the Bluetooth wireless device with a USB interface connects to a host system via a USB cable. After the host system is booted, the Bluetooth control program of the host system automatically detects and acquires data at a control terminal of the Bluetooth device. The Bluetooth control program further gives a Bluetooth device address to the Bluetooth device and stores the address in the Bluetooth device and the memory of the host system.

### BACKGROUND OF THE INVENTION

1. Field of Invention

The invention relates to a method of detecting and actuating of a Bluetooth device and a control system of Bluetooth devices, and more particularly to a method of detecting the actuation of a Bluetooth device and a control system of a Bluetooth device in which the Bluetooth device is recognized via wire transmission.

2. Related Art

Protocol is a wireless short-distance communication technology that has attracted a lot of attention. Its main goal is to create a smooth wireless transmission environment for universal communication. In addition to cable replacement, another goal is to allow communication related equipment manufactured from different producers to be mutually compatible. This gives electronic products, such as cell phones, the ability of wireless data transmission via the communication related equipment. Wireless transmission technology, compared to wire transmission technology, is favorable in convenience of installation and use. A USB is one standard fitting for wire transmission, while a Bluetooth device is one standard piece of equipment for wireless transmission. Other wireless transmission technologies that have been developing include UWB (ultra wideband) at 2.45 GHz and 40 Mbps, HyperLan and HomeRF, their influence extending to the whole 3C industry. Bluetooth technology mainly includes a wireless transmitter and a wireless receiver. Bluetooth technology combines the wireless transmitter and the wireless receiver together for communication between devices under the network transmission concept and thus meets the command for the current transmission. Bluetooth transmission is performed by means of Radio frequency (RF) at 2.4 GHz, the frequency band being used in some of high-grade wireless telephones. In the future, Bluetooth technology will be applied in every electronic device or electrical appliance to ensure smooth short-distance transmission there between. Bluetooth technology is therefore at a standard frequency band of wireless transmission. The Bluetooth technology searches a non-used channel having the lowest interface and least noise among 79 channels by frequency hopping and spread spectrum to keep the transmission quality and speed as good as possible.

Bluetooth technology may transmit information such as data or voice signals. Each Bluetooth device may be set to master mode or slave mode. When other Bluetooth devices are found, the mater device is responsible for organizing and leading the communication between the master and slave devices in order to perform peer-to-peer or peer-to-many transmission according to the attributes of the devices. For the peer-to-peer transmission, a piconet is built between the two Bluetooth devices but is not affected by other Bluetooth devices. A piconet allows at most 8 bluetooth devices to transmit simultaneously. For peer-to-many transmission, the master device may perform wireless transmission to at most 7 slave devices at one time. Thereby, a scatternet is formed. All the Bluetooth devices form a LAN after being combined.

Microsoft has produced a Bluetooth wireless optical keyboard/mouse module that has built a Bluetooth receiver terminal driver into the keyboard and the mouse. The installation of the Bluetooth wireless mouse driver is based on an old-type keyboard and mouse. The receiver is connected to the old-type mouse. The Bluetooth mouse is recognized and given a code. Then, the Bluetooth keyboard driver is installed. The Bluetooth keyboard is recognized given another code. Thereafter, the host system is shut off, and the old-type keyboard and mouse are removed. When the host system is rebooted, the Bluetooth keyboard/mouse module operates.

The prior art has the following disadvantages. The installation of the driver for the Bluetooth keyboard or mouse must rely on the old-type keyboard and mouse. Furthermore, the Bluetooth function of the Bluetooth keyboard cannot be used under DOS mode or before the frame goes into WINDOWS®. When the host system cannot find the keyboard or mouse, it cannot change BIOS settings. Furthermore, if the Bluetooth keyboard or mouse is to be used long term, it must either connect to an external power supply or have a spare battery. When the Bluetooth wireless transmission is interfaced, the Bluetooth keyboard or mouse cannot be used anymore. The conventional Bluetooth device has difficulty initializing Bluetooth transmission due to the inability to sense the Bluetooth device. The above disadvantages cause inconvenience in use.

As described above, there is a need for a technology that is applied in the Bluetooth keyboard, mouse or other related devices without the need of the old-type mouse and keyboard to initialize the Bluetooth function of the Bluetooth keyboard and mouse. Furthermore, there is also a need of a Bluetooth device capable of initializing the Bluetooth function when the frame is under DOS mode or before the frame goes into WINDOWS®, and of changing the BIOS settings. Even when the power is low, the Bluetooth device still works without replacing the battery. There is no concern about the operation duration of the Bluetooth device, which is very convenient to use. The Bluetooth device can be used as a master device to automatically detect other Bluetooth slave devices such as that for the refrigerator, television set, lighting and so on.

### SUMMARY OF THE INVENTION

An object of the invention is therefore to provide a method of detecting actuation of a Bluetooth wireless device and a control system thereof, which solves or eliminates the prior problems.

Another object of the invention is to provide a method of detecting actuation of a Bluetooth wireless device, in which a Bluetooth control program of a host system actuates the Bluetooth wireless transmission of the Bluetooth device via a USB cable after the Bluetooth device connects to the host system via a USB interface and a USB cable, thereby eliminating the difficulty of performing Bluetooth transmission.

It is still another object of the invention to provide a method of charging a Bluetooth wireless device, in which when the Bluetooth device connects to a host system via a USB interface and a USB cable, the Bluetooth device is able to supplement electrical power.

Yet another object is to provide a control system for a Bluetooth wireless device, the control system being used as a Bluetooth wireless master device to detect whether the Bluetooth functions of other Bluetooth wireless slave devices are actuated and control the Bluetooth wireless slave devices, after the Bluetooth wireless device connects to the host system via a USB interface and a USB cable to actuate its Bluetooth wireless transmission function.

In order to achieve the above and other objectives, a control system for a Bluetooth device of the invention forms a wire data transmission path by connecting a host system to a USB cable via a USB interface, and forms a wireless data transmission path between a Bluetooth transmission interface and the host system by means of Bluetooth protocol. A control unit stores a Bluetooth wireless device address in its memory to actuate the Bluetooth wireless function and control the data transmission. A power supply provides the control unit with power.

In order to achieve the above and other objectives, a method of detecting the actuation of the Bluetooth wireless device includes the following steps. When the Bluetooth device is used first time, a Bluetooth wireless device with a USB interface connects to a host system via a USB cable. The host system is booted. A Bluetooth control program for the host system initializes and actuates the Bluetooth wireless function via the USB cable. Then, the USB may be removed or not. At this time, the Bluetooth wireless transmission of the Bluetooth wireless device is ready for use. When the Bluetooth wireless device is to be used again, the host system is booted to allow the Bluetooth control program of the host system to automatically detect the initialized Bluetooth function of the Bluetooth wireless device and start the Bluetooth wireless transmission.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic view of the use of a Bluetooth wireless device for the first time according to a first embodiment of the invention;

FIG. 2 is a schematic view of the use of a Bluetooth wireless device again according to a first embodiment of the invention;

FIG. 3 is a schematic view of the use of a plurality of Bluetooth wireless devices for the first time according to a second embodiment of the invention;

FIG. 4 is a schematic view of the use of a plurality of Bluetooth wireless devices again according to a second embodiment of the invention; and

FIG. 5 is a schematic view of the use of a plurality of Bluetooth wireless devices according to a third embodiment of the invention.

### DETAILED DESCRIPTION OF THE INVENTION

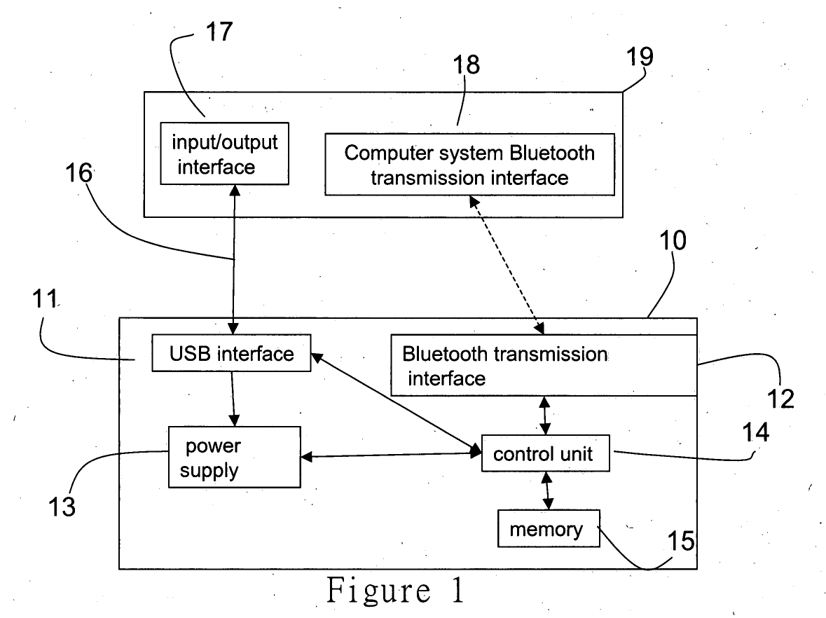

Referring to FIG. 1, which is a schematic view of a method of detecting and actuating of a Bluetooth wireless device according to a first embodiment of the invention, the method of detecting actuation of the Bluetooth wireless device includes a Bluetooth wireless device 10 and a host computer system 19. The Bluetooth wireless device 10 includes a USB interface 11, a Bluetooth transmission interface 12, a power supply 13, a control unit 14 and memory 15. The USB interface 11 connects to the host computer system 19 to form a wire data transmission pathway and an electrically charging pathway. The Bluetooth transmission interface 12 connects to the host computer system 19 to form a wireless data transmission pathway. The control unit 14 stores a Bluetooth wireless device address in its memory 15 to start and control the Bluetooth wireless transmission, and automatically detect other Bluetooth devices, if any, after the first Bluetooth wireless transmission is started. The power supply 13 supplies the control unit 14 with power. The Bluetooth device allows the user to input data to the host system or other Bluetooth devices such as the Bluetooth mouse, Bluetooth keyboard or Bluetooth controller. The host computer system 19 at least includes an input/output interface 17, a host computer system Bluetooth wireless transmission interface 18, and a Bluetooth control program. The input/output interface 17 connects to the Bluetooth wireless device 10 to form a wire data transmission pathway. The host computer Bluetooth wireless transmission interface 18 connects to the Bluetooth wireless device 10 to form the wireless data transmission pathway. The Bluetooth control program actuates the Bluetooth function of the Bluetooth wireless device.

Referring to FIG. 1, a method of installing the Bluetooth wireless device 10 involves connecting the input/output interface 17 of the host computer system 19 to the USB interface 11 of the Bluetooth wireless device 10 via a USB cable 16. After the host computer system 19 is booted, the Bluetooth control program of the host computer system 19 automatically detects via the input/output interface 17 whether the Bluetooth wireless device 10 exists. Data of the Bluetooth wireless device 10 is acquired via the USB cable 16 from the memory 15 of the Bluetooth device 10. The control unit 14 is given a Bluetooth wireless device address via the input/output interface 17, the USB cable 16 and the USB interface 11. The control unit 14 stores the Bluetooth wireless device address in the memory 15. The Bluetooth control program gives the control unit 14 a signal to actuate the Bluetooth wireless transmission. The Bluetooth wireless device 10 performs wireless data transmission via the Bluetooth transmission interface 22 and Bluetooth wireless transmission interface 18 of the host computer system 19. Furthermore, the host computer system 19 charges the power supply 13 of the Bluetooth wireless device 10 via the USB cable 16. The user decides whether or not to use the USB cable 16 according to the available power capacity for the Bluetooth wireless device 10 shown on the host system 19. When the electrical charging is finished, the USB cable 16 can be removed but does not have to be. If the USB cable 16 is removed after charging and the control unit 14 does not receive signals from the USB interface 1, the control unit 14 performs data transmission via the Bluetooth transmission interface 12 and the Bluetooth wireless transmission interface 18 of the host computer system 19.

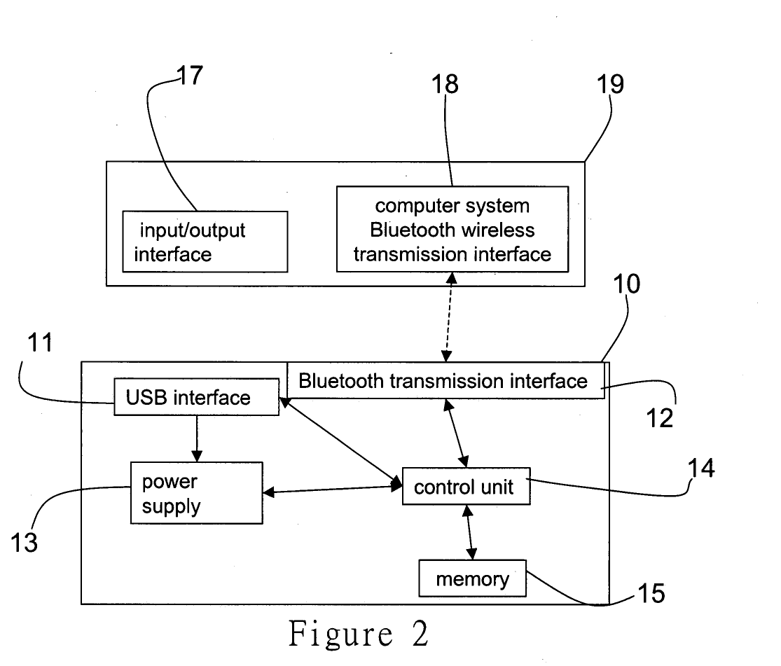

FIG. 2 is a schematic view of a method of detecting and actuating of a Bluetooth wireless device according to a first embodiment of the invention. When the Bluetooth wireless device 10 that has been installed is to be restarted, the Bluetooth control program of the host computer system 19 automatically actuates the existing Bluetooth wireless device 10 via the Bluetooth wireless transmission interface 18 after the host system is booted. At this time, the Bluetooth wireless device 10 is ready for use. The Bluetooth control program also detects whether the USB cable 16 exists via the control unit 14. If there is no USB cable 16 to connect the host computer system 19 to the Bluetooth wireless device 10, then the control unit 14 performs the wireless data transmission via the Bluetooth transmission interface 12 and the host computer system 19. The control unit 14 further provides information regarding available power capacity for the Bluetooth wireless device 10 so the user can decide whether to connect or disconnect the USB cable 16 to or from the host system 19 and the Bluetooth wireless device 10. If the USB cable 16 connects the host computer system 19 to the Bluetooth wireless device 10, the control unit 14 performs wire data transmission via the USB interface 11, the USB cable 16, the input/output interface 17 and the host computer system 19. The control unit 14 provides the host computer system 19 with the information regarding the available power capacity for the Bluetooth wireless device 10 via the USB interface 11, the USB cable 16 and the input/output interface 17 for the user to decide whether the USB cable 16 can be removed to perform wireless data transmission.

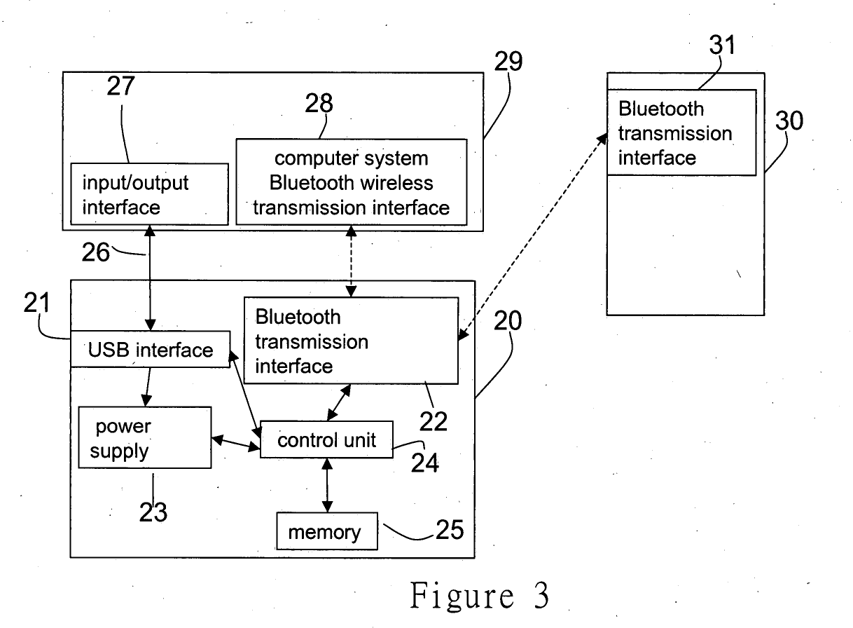

FIG. 3 is a schematic view of a method of detecting and actuating of a Bluetooth wireless device according to a second embodiment of the invention. A system used to execute the method of detecting the actuation of a Bluetooth wireless device includes a Bluetooth wireless master device 20, at least one Bluetooth wireless slave device 30 and a host computer system 29. The Bluetooth wireless master device 20 includes a USB interface 21, a Bluetooth transmission interface 22, a power supply 23 and a control unit 24. The USB 21 connects to the host computer system 29 to form wire data transmission and an electrically charging pathway. The Bluetooth transmission interface 22 connects to the host computer system 29 to form a wireless data transmission pathway. The control unit 24 stores a Bluetooth wireless device address in its memory 25 to actuate Bluetooth wireless transmission and control the type of data transmission. The power supply 23 supplies the control unit 24 with power. The Bluetooth wireless slave device 30 includes a Bluetooth transmission interface 31, a control unit (not shown) and a power supply. The Bluetooth transmission interface 31 connects the host computer system 29 to the Bluetooth wireless master device 20 to form a wireless data transmission pathway. The control unit (not shown) stores a Bluetooth wireless device address in its memory (not shown) to actuate Bluetooth wireless transmission and control the type of data transmission to the host computer system 29. The power supply (not shown) supplies the control unit (not shown) with power. The host computer system 29 at least includes an input/output interface 27, a host computer system Bluetooth wireless transmission interface 28, and a Bluetooth control program. The input/output interface 27 connects to the Bluetooth wireless device 20 to form a wire data transmission pathway. The host Bluetooth wireless transmission interface 28 connects to the Bluetooth wireless device 20 to form the wireless data transmission pathway. The Bluetooth control program actuates the Bluetooth function of a plurality of Bluetooth wireless devices. The Bluetooth wireless salve device 30 further includes a USB interface (not shown) to form wire data transmission and an electrically charging pathway.

Referring to FIG. 3, a method of installing a plurality of Bluetooth wireless devices and a control system thereof involves connecting the input/output interface 27 of the host computer system 29 to the USB interface 21 of one Bluetooth wireless device 20 via a USB cable 26. After the host computer system 29 is booted, the Bluetooth control program of the host computer system 29 automatically detects via the input/output interface 27 whether the Bluetooth wireless device 20 exists. Data of the Bluetooth wireless device 20 is acquired via the USB cable 26 from the memory 25. The control unit 24 is given a Bluetooth wireless device address via the input/output interface 27, the USB cable 26 and the USB interface 21. After the control unit 24 stores the Bluetooth wireless device address in its memory 25, the Bluetooth control program gives the control unit 24 a signal to actuate Bluetooth wireless transmission. The Bluetooth wireless device 20 performs wireless data transmission via the Bluetooth transmission interface 22 and the Bluetooth wireless transmission interface 28 of the host computer system 29. When the Bluetooth wireless master device 20 actuates wireless transmission, the Bluetooth control program of the host computer system 29 or the control unit 24 of the Bluetooth wireless device 20 detects whether there are other Bluetooth wireless slave devices 30 via the Bluetooth transmission interface 22 of the Bluetooth wireless master devices-20. If there are slave devices, the slave devices are given respective addresses that are stored in corresponding memories (not shown) of the slave devices. The wireless transmission of other Bluetooth wireless slave devices is executed in the same way as above. The user can make one of the Bluetooth wireless devices the master device, and the remaining devices slave devices according to the method of wireless data transmission, via the Bluetooth control program of the host computer system 29. The master device is used as a control system for those slave devices in the above manner of wireless transmission. Furthermore, the host computer system 29 charges the power supply 23 of the Bluetooth wireless device 20 with the USB interface 21 via the USB cable 26. The user decides whether the USB cable 26 can be removed according to the available power capacity for the Bluetooth wireless device 20 shown on the host computer system 29. When the electrical charging is finished, the USB cable 26 can be removed but does not have to be. If the USB cable 26 is removed after charging and the control unit 24 does not receive signals from the USB interface 21, data transmission is performed via the Bluetooth transmission interface 22 and the Bluetooth wireless transmission interface 28 of the host computer system 29.

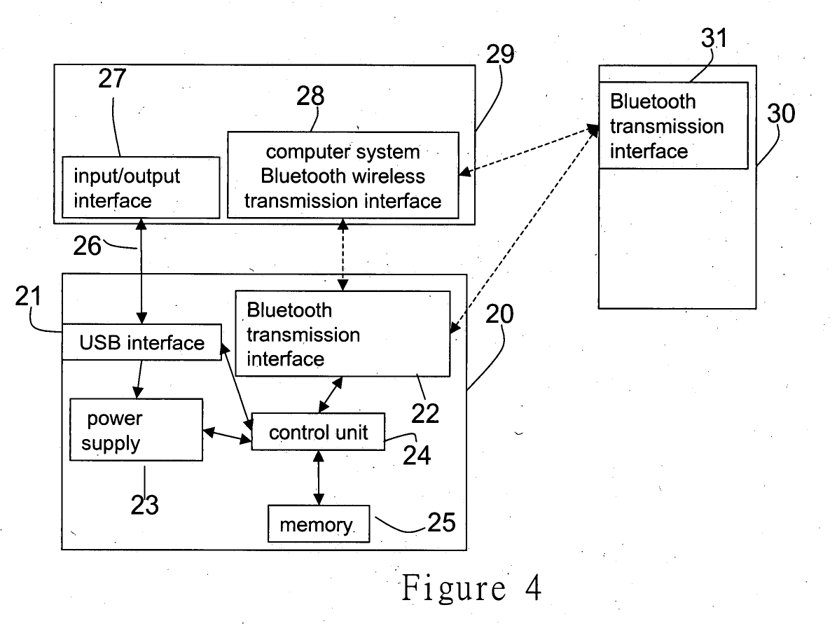

FIG. 4 is a schematic view of the use of a plurality of Bluetooth wireless devices after the Bluetooth wireless devices have been installed according to a second embodiment of the invention. If the Bluetooth wireless device 20 that has been installed is to be restarted, the Bluetooth control program of the host computer system 29 automatically actuates the existing Bluetooth wireless devices 20 and 30 via the Bluetooth wireless transmission interface 28 after the host system is booted. One of the Bluetooth wireless devices is assigned as a Bluetooth wireless master device and the remaining are assigned as Bluetooth wireless slave devices. The master device is used for control of those slave devices. The control unit 24 of either of the wireless devices 20 or 30 detects whether there is a USB cable (not shown). If there is no USB cable (not shown) to connect the host computer system 29 to either of the Bluetooth wireless devices 20 or 30, then the control unit 24 performs wireless data transmission via the Bluetooth transmission interface 22 and the host computer system 29. The control unit 24 further provides information regarding available power capacity for the Bluetooth wireless devices 20 and 30 for the user to decide whether to connect or disconnect the USB cable 26 to or from the host computer system 29 and the Bluetooth wireless devices 20 and 30. If the USB cable (not shown) connects the host computer system 29 to one of the Bluetooth wireless devices 20 or 30, then the control unit 24 performs the wire data transmission to the host computer system 29 via the USB interface 21, the USB cable (not shown) and the input/output interface 27. The host computer system 29 supplies the devices 20 and 30 with power via the USB cable (not shown). The control unit 24 provides the host system 19 with information regarding the available power capacity for the Bluetooth wireless devices 20 and 30 via the USB interface 21, the USB cable (not shown) and the input/output interface 27 for the user to decide whether the USB cable (not shown) can be removed to perform wireless data transmission.

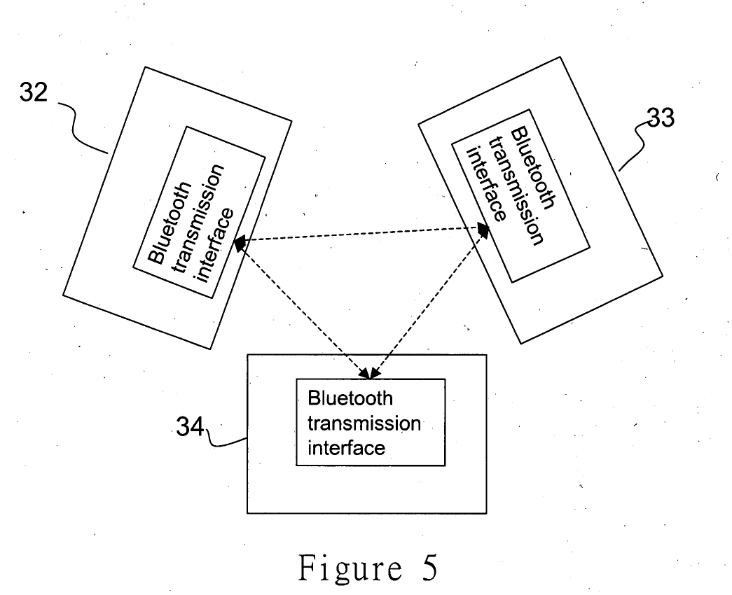

FIG. 5 is a schematic view of the operation of a plurality of Bluetooth wireless devices and a control system thereof according to a third embodiment of the invention. A plurality of Bluetooth devices 32, 33 and 34 are installed in the way described above, among which a master device is defined and the remaining devices are assigned as slave devices. When the Bluetooth wireless devices are to be used without booting the host system, the Bluetooth wireless master device 34 automatically detects and drives at least one of the Bluetooth wireless slave devices to perform wireless transmission. The Bluetooth wireless master device 34, in this embodiment, is used for control of those Bluetooth slave wireless devices to control the at least one of the Bluetooth wireless slave devices 32 and 33.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of detecting and actuating of a Bluetooth device to perform data transmission to a host computer system via a control terminal of the Bluetooth device, the method comprising:
actuating the host computer system when the Bluetooth device is used first time, wherein one Bluetooth control program of the host computer system automatically detects and acquires data from the control terminal of the Bluetooth device via a cable; and
the Bluetooth control program giving the Bluetooth device a Bluetooth device address via the cable, wherein the Bluetooth device address is stored in the memory of Bluetooth device and the host computer system.

2. The method of claim 1, wherein the Bluetooth device includes a Bluetooth mouse, a Bluetooth keyboard and a Bluetooth controller for data control and data input of the host computer system or other Bluetooth devices.

3. The method of claim 1, wherein the cable is a USB cable.

4. The method of claim 1, wherein the USB cable is a pathway for electrically charging the Bluetooth device.

5. The method of claim 1, further comprising a control unit for detecting and receiving signals from a wire interface and a Bluetooth transmission interface of the Bluetooth device, wherein when a signal comes from the cable, the Bluetooth device performs data transmission via the cable; when there is no signal coming from the cable, the Bluetooth device performs data transmission via the Bluetooth transmission interface.

6. A method of detecting and actuating of a plurality of Bluetooth devices to perform data multi-transmission to a host computer system via a control terminal of one Bluetooth master device, the method comprising:
a Bluetooth control program of the host computer system actuating the Bluetooth transmission function of the Bluetooth master device via a cable when the Bluetooth devices are used first time; and
the Bluetooth control program of the host computer system linking to the Bluetooth master device via wire or wireless transmission, and initializing Bluetooth transmission of other Bluetooth devices in a way of Bluetooth transmission via the Bluetooth master device.

7. The method of claim 6, wherein the cable is a USB cable.

8. A control system of a Bluetooth device, in which data input or control to a host system or to other Bluetooth devices is performed in a wireless or wire way, the control system at least comprising:
a wire interface, connecting to the host system to form a wire data transmission pathway and an electrically charging pathway;
a Bluetooth transmission interface, connecting to the host system to form a: wireless data transmission pathway;
a control unit, receiving signals from the wire interface and the Bluetooth transmission interface to actuate the Bluetooth transmission, and perform data exchange with the host system or other Bluetooth devices through the wireless or wire data transmission;
power supply, supplying the control unit with power; and
the memory, storing a signal from the control unit.

9. The control system of claim 8, wherein the Bluetooth transmission is actuated by giving the control unit of the Bluetooth device a signal via a cable by the Bluetooth control program of the host computer system. 10. The control system of claim 9, wherein the cable is a USB cable.
